(19) United States
(12) Patent Application Publication
(10) Pub. No.: US 2013/0300943 A1
(43) Pub. Date: Nov. 14, 2013

(54) RECRIVER AND BROADCAST PROGRAM RECEIVING METHOD

(71) Applicant: KABUSHIKI KAISHA TOSHIBA, Tokyo (JP)

(72) Inventor: Hirotada Hirabayashi, Hamura-shi (JP)

(73) Assignee: KABUSHIKI KAISHA TOSHIBA, Tokyo (JP)

(21) Appl. No.: 13/789,135

(22) Filed: Mar. 7, 2013

(30) Foreign Application Priority Data
May 10, 2012 (JP) 2012-108635

(51) Int. Cl. H04N 5/50

(52) U.S. Cl. CPC H04N 5/50
USPC 348/731

(57) ABSTRACT

According to one embodiment, a receiver is configured to calculate first moving average of reception quality information output within first period, to calculate second moving average of the information output within second period, to reproduce a broadcast program based on the strong-layer broadcast signal if the first moving average is lower than first threshold corresponding to the first moving average, and to reproduce a broadcast program based on the weak-layer broadcast signal if the second moving average is higher than second threshold corresponding to the second moving average.

### CROSS-REFERENCE TO RELATED APPLICATIONS

This application is based upon and claims the benefit of priority from Japanese Patent Application No. 2012-108635, filed May 10, 2012, the entire contents of which are incorporated herein by reference.

### FIELD

Embodiments described herein relate generally to a receiver and a broadcast program receiving method.

### BACKGROUND

At present, in Japan, first layer broadcasting for mobile terminals (strong layer or one-segment broadcasting) and, for fixed stations, broadcasting having a weaker layer than the first layer (weak layer or full-segment broadcasting) are provided for integrated services digital broadcasting-terrestrial (ISDB-T).

Since full-segment broadcasting may be viewed while a person is moving, a tuner capable of receiving both one-segment broadcasting and full-segment broadcasting is provided thereby to switch one-segment broadcasting and full-segment broadcasting according to a reception quality.

If one-segment broadcasting and full-segment broadcasting are simply switched according to a reception quality, switching frequently occurs and thus viewing is difficult. Thus, there is an example in which such a tuner is provided with two thresholds for switching from full-segment broadcasting to one-segment broadcasting, thereby preventing frequent switching. However, the system has a problem that switching frequently occurs for a large variation over the two thresholds.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an outline of a receiver according to an embodiment;

FIG. 2 is an exemplary block diagram illustrating an exemplary system structure of the receiver of FIG. 1;

FIG. 3 is an exemplary diagram illustrating a structure of one channel band for terrestrial digital TV broadcast;

FIG. 4 is an exemplary block diagram illustrating an exemplary structure of a tuner and a TV viewing program according to the embodiment;

FIG. 5 is an exemplary flowchart illustrating a procedure of switching processing between one-segment broadcasting and full-segment broadcasting;

FIG. 6 is an exemplary diagram illustrating how to switch one-segment broadcasting and full-segment broadcasting according to the method of the embodiment and a comparative method; and

FIG. 7 is an exemplary diagram illustrating changes in BER, a simple moving average of the latest three BERs, and a simple moving average of the latest six BERs.

### DETAILED DESCRIPTION

Various embodiments will be described hereinafter with reference to the accompanying drawings.

In general, according to one embodiment, a receiver comprises a tuner, a first determination module, a second determination module, and a reproduction processor. A tuner is configured to receive a strong-layer broadcast signal and a weak-layer broadcast signal from one channel and to output items of reception quality information based on one of the strong-layer broadcast signal and the weak-layer broadcast signal. A first determination module is configured to calculate first moving averages corresponding to moving averages of the items of the reception quality information output within a first period, and to determine whether each first moving average is lower than each first threshold corresponding to each first moving average. A second determination module is configured to calculate second moving averages corresponding to moving averages of the items of the reception quality information output within a second period, and to determine whether each second moving average is higher than each second threshold corresponding to each second moving average. A reproduction processor is configured to reproduce a strong-layer broadcast program based on the strong-layer broadcast signal if each first moving average is lower than each first threshold corresponding to each first moving average, and to reproduce a weak-layer broadcast program based on weak-layer broadcast signal if each second moving average is higher than each second threshold corresponding to each second moving average.

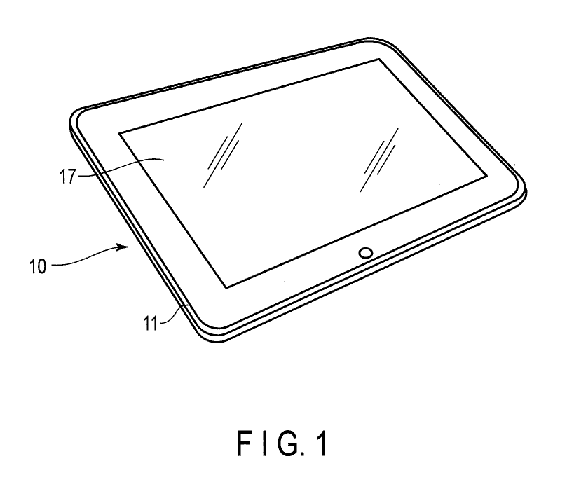

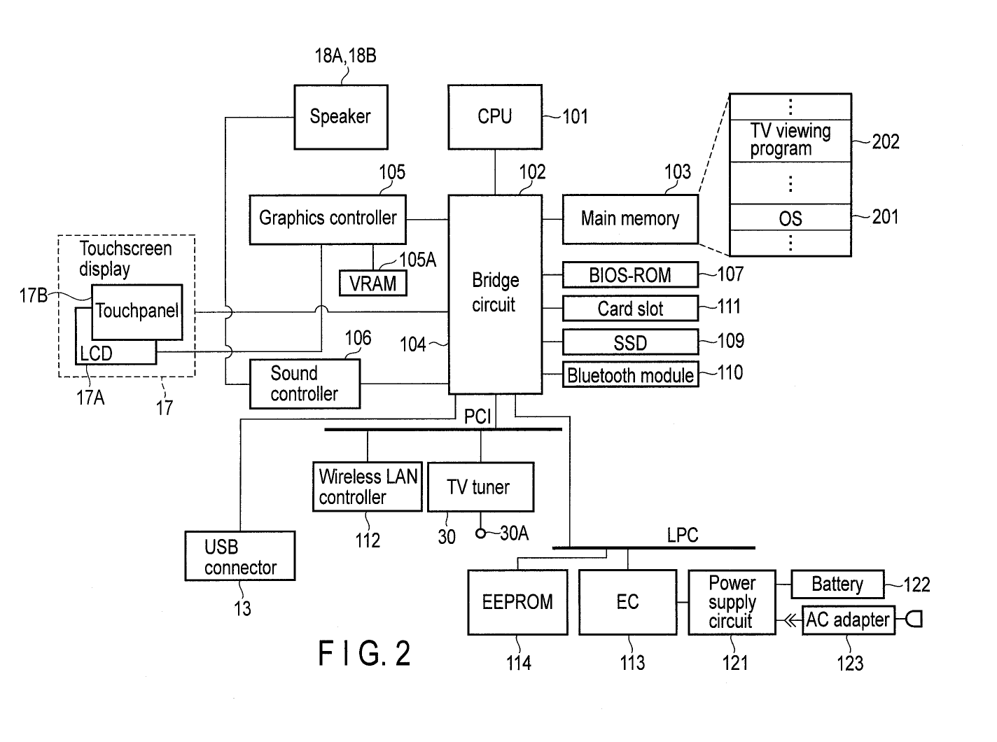

A structure of an information processing apparatus (receiver) according to one embodiment will be described first with reference to FIG. 1 and FIG. 2.

FIG. 1 is a perspective view illustrating an outline of the receiver according to one embodiment. The receiver can be realized by a tablet computer, a notebook computer, a smartphone, a PDA or the like. There will be assumed below that the receiver is realized as a tablet computer 10. The tablet computer 10, also called a slate computer, is a portable broadcast program receiving apparatus, and comprises a main body 11 and a touchscreen display 17 as illustrated in FIG. 1. The touchscreen display 17 is attached to overlap on the upper surface of the main body 11.

FIG. 2 is a block diagram illustrating an exemplary system structure of the computer 10.

The computer 10 comprises a central processing unit (CPU) 101, a bridge circuit 102, a main memory 103, a graphics controller (GPU) 105, a sound controller 106, a BIOS-ROM 107, a solid-state drive (SSD) 109, a Bluetooth (trademark) (BT) module 110, a card slot 111, a wireless LAN controller 112, an embedded controller (EC) 113, an EEPROM 114, a USB connector 13, the touchscreen display 17, a video memory (VRAM) 105A and a tuner 30.

The CPU 101 is a processor configured to control the operations of the respective units in the computer 10. The CPU 101 executes an operating system (OS) 201 and various application programs loaded from the SSD 109 into the main memory 103. The application programs include a TV viewing program 202.

The TV viewing program 202 executes a live reproduction processing for viewing broadcast program data received by the TV tuner 30, processing of displaying an electronic program guide based on electronic program data received by the TV tuner 30, and the like.

Android (trademark) is assumed as the OS 201 in the present embodiment. That is, a system using the Android (trademark) OS is assumed and the computer 10 is assumed to be an apparatus on which Android (trademark) is installed. In the present embodiment, the OS 201 installed on the computer 10 may be an OS other than Android (trademark). That is, since the system described in the present embodiment can be a system using another OS, the system described in the present embodiment can be applied to a computer 10 on which an OS other than Android (trademark) is installed.

The CPU 101 executes a basic input/output system (BIOS) stored in a BIOS-ROM 107. The BIOS is a program for hardware control.

The bridge circuit 102 is a bridge device configured to connect a local bus of the CPU 101, each device on a Peripheral Component Interconnect (PCI) bus, and each device on a Low Pin Count (LPC) bus. Further, the bridge circuit 102 incorporates a serial Advanced Technology Attachment (ATA) controller for controlling the SSD 109 therein. Further, the bridge circuit 102 has a function of making communication with the sound controller 106. Alternatively, the bridge circuit 102 a function of making communication with the GPU 105 via a serial bus in the PCIEXPRESS standard.

The GPU 105 is a display controller configured to control a LCD 17A used as a display monitor of the computer 10. A video signal (which may be called a display signal) generated by the GPU 105 is sent to the LCD 17A.

The sound controller 106 is a sound source device, and outputs audio data to be reproduced to a speaker 18A and a speaker 18B. The wireless LAN controller 112 is a wireless communication device configured to make wireless communication conforming to the IEEE 802.11 standard, for example.

The EC 113 is an embedded controller for power management. The EC 113 has a function of powering on and powering off the computer 10 in response to a user operation. The power supply circuit 121 uses power supplied from a battery 122 inside the computer 10 or power supplied from an external power supply such as an AC adapter 123 to generate operation power to be supplied to each component. The power supply circuit 121 uses power supplied from an external power supply to charge the battery 122.

The touchscreen display 17 is incorporated with a touchpanel 17B in addition to the LCD 17A. The touchpanel 17B arranged to overlap on the LCD 17A has a sensor, a microcontroller unit (MCU), and the like. When a touch operation is performed on the touchpanel 17B, the touched position is detected by the sensor, and input information including the touched position on the touchpanel 17B is output by the MCU.

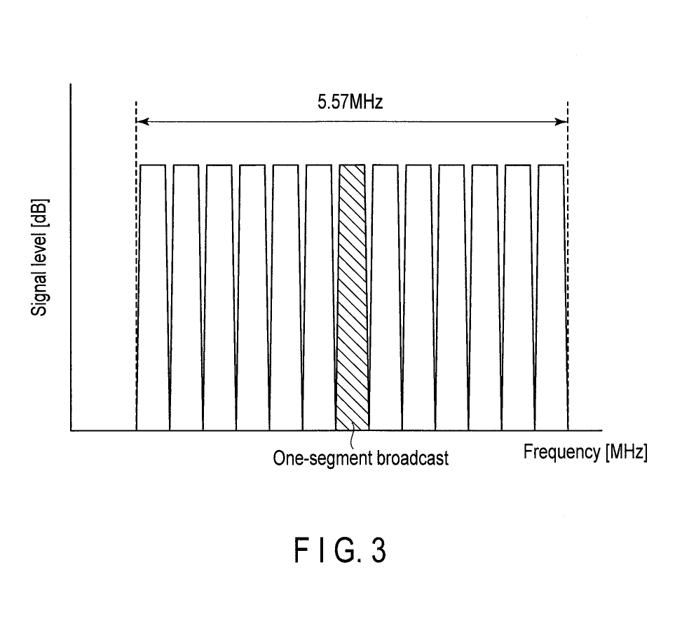

The TV tuner 30 is a receiving device configured to receive digital broadcast programs such as terrestrial digital TV broadcasts, and is connected to an antenna terminal 19. As illustrated in FIG. 3, one channel (5.57-MHz band) in terrestrial digital TV broadcasting is configured to be divided into 13 segments. One segment in the center band in the 5.57-MHz band is used to perform one-segment partial reception service for cellphones and mobile terminals (one-segment broadcasting). The remaining 12 segments (full-segment broadcasting) are used to perform high-definition television (HDTV) broadcasting or standard-definition television (SDTV) broadcasting. High-definition broadcasting uses 12 segments and standard-definition broadcasting uses four segments.

In ISDB-T broadcasting, the respective segments can be variously modulated (up to three hierarchies). ISDB-T can use modulation systems such as differential quadrature phase-shift keying (DQPSK), quadrature phase-shift keying (QPSK), 16 quadrature amplitude modulation (QAM) and 64QAM. For example, full-segment broadcasting uses 64QAM. One-segment broadcasting uses QPSK which is more resistant for failures or multipath than 64QAM. In terrestrial digital broadcasting, one-segment broadcasting is called strong layer and full-segment broadcasting is called weak layer.

An ISDB-T broadcast is transmitted using the Band Segmented Transmission-Orthogonal Frequency Division Multiplexing (BST-OFDM) system. The BST-OFDM system will be described. Data to be transmitted is divided into 5,617 carriers and each item of data is subjected to digital modulation such as QPSK or QAM. A carrier frequency corresponding to one item of data (subcarrier) is 0.992 kHz. The 5,617 carriers of 0.992 kHz are tightly arranged thereby to form an OFDM signal for one channel of TV in the 5.57-MHz band.

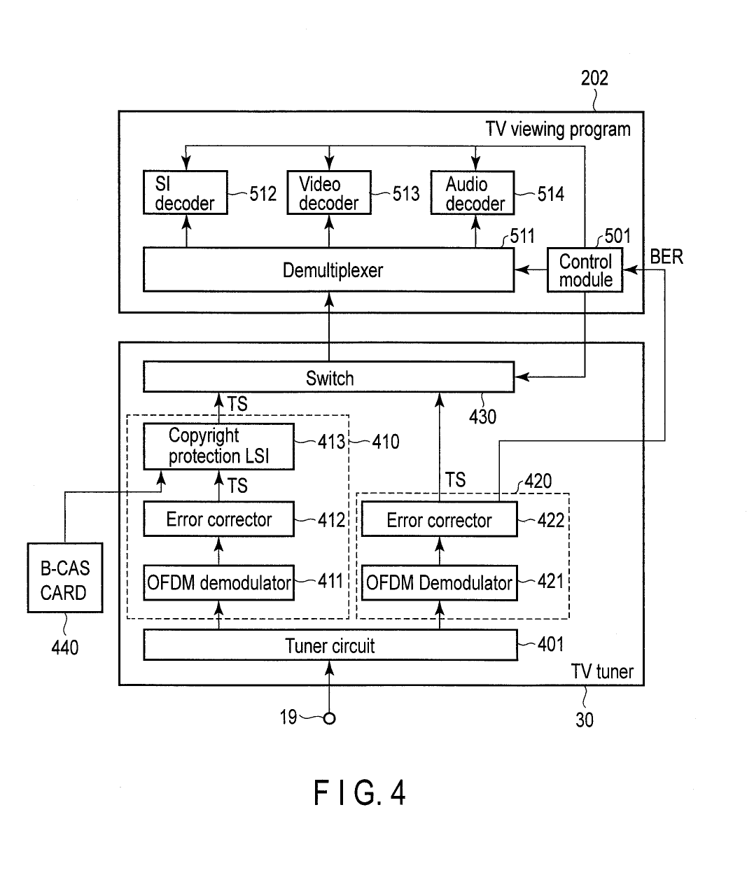

A structure of the TV tuner 30 and the TV viewing program 202 for reproducing digital broadcasting will be described with reference to FIG. 4.

The TV tuner 30 comprises a tuner circuit 401, a full-segment module 410, a one-segment module 420 and a switch 430.

The tuner circuit 401 uses a respective mixer to convert a frequency signal component corresponding to a desired reception channel among the digital broadcast signals (high-frequency signals) input from the antennal terminal 19 into an intermediate frequency signal, and uses an amplifier to amplify the intermediate frequency signal to a predetermined power level to be input to the full-segment module 410 and the one-segment module 420.

The full-segment module 410 comprises an OFDM demodulator 411, an error corrector 412 and a copyright protection LSI 413.

The OFDM demodulator 411 digitizes the analog intermediate frequency signals from the tuner circuit 401, orthogonally demodulates and converts the resulting digital signals into complex digital signals, performs fast Fourier transformation (FFT) on the complex digital signals and decomposes them into subcarrier signals on the frequency axis, and then outputs demodulation signals for reproducing full-segment broadcasting. The OFDM demodulator 411 can output a carrier-to-noise power ratio (C/N ratio) value detected during the demodulation.

With ISDB-T, encoding for error correction is performed by Reed-Solomon and convolution codes. The error corrector 412 detects an error, corrects the detected error, and outputs an error correction signal and a bit error rate (BER).

Data output from the error corrector 412 is encoded in a digital broadcast limited reception system (MULTI2) code. The copyright protection LSI 413 uses a decode key stored in a Broadcasting Satellite-Conditional Access System (B-CAS) card 440 to decode the output from the MULTI2 system and to obtain a transport stream (TS) signal. The copyright protection LSI performs local encoding for streaming in a general-purpose bus such as PCI, and sends the stream to the CPU via the PCI bus.

The one-segment module 420 comprises an OFDM demodulator 421 and an error corrector 422. The OFDM demodulator 421 digitizes the analog intermediate frequency signals from the tuner circuit 401, orthogonally demodulates and converts the resulting digital signals into complex digital signals, and performs fast Fourier transformation (FFT) on the complex digital signals and decomposes them into subcarrier signals on the frequency axis, and then outputs demodulation signals for reproducing one-segment broadcasting. The OFDM demodulator 421 can output a carrier-to-noise power ratio (C/N ratio) value detected during the demodulation.

With ISDB-T, encoding for error correction is performed by Reed-Solomon and convolution codes. The error corrector 422 detects an error, corrects the detected error, and outputs an error correction signal (transport stream [TS]).

The switch 430 outputs one of a TS signal output from the full-segment module 410 and a TS signal output from the one-segment module 420 to the TV viewing program 202 under control of a control module described later.

The TV viewing program 202 for reproducing a signal from the TV tuner 30 comprises the modules such as a control module 501, a demultiplexer 511, a SI decoder 512, a video decoder 513 and an audio decoder 514. The modules of the TV viewing program 202 are performed by the CPU 101.

The control module 501 as a first determination module and a second determination module periodically obtains the BERs from the one-segment module 420 in the TV tuner 30, and stores the obtained BERs in the main memory 103. The main memory 103 stores the latest six BERs, for example. The control module 501 requests the TV tuner 30 to output a TS signal based on one of a full-segment broadcast signal and a one-segment broadcast signal depending on the BERs stored in the main memory 103.

The control module 501 calculates a simple moving average SMA₃ of the latest three BERs and a simple moving average SMA₆ of the latest six BERs, for example. When simple moving average SMA₃ is lower than a threshold THA₃ and simple moving average SMA₆ is lower than a threshold THA₆, the TV tuner 30 is requested to output a TS signal based on the one-segment broadcast signal. When simple moving average SMA₃ is higher than a threshold THB₃ and simple moving average SMA₆ is higher than a threshold THB₆, the control module 501 requests the TV tuner 30 to output a TS signal based on the full-segment broadcast signal. The TV tuner 30 supplies a TS signal in response to the request from the control module 501 to the TV viewing program 202. When making the same request as the last request, the control module 501 makes no request.

The demultiplexer 511 separates program-specific information/service information (PSI/SI), video data and audio data from the TS signal output from the TV tuner 30. The demultiplexer 511 outputs the separated PSI/SI to the PSI/SI decoder 512, outputs the separated video data to the video decoder 513, and outputs the separated audio data to the audio decoder 514.

The PSI/SI decoder 512 decodes the PSI/SI. Program-specific information (PSI) identifies information contained in each TS packet, and service information (SI) extends the PSI to contain program information such as program names and an electronic program guide (EPG). The control module 501 notifies the video decoder 513 whether PSI/SI data to be input is for full-segment broadcasting or one-segment broadcasting.

The video decoder 513 as a reproduction processing module decodes the video data. A video is displayed on the LCD based on the decoded video data. Video data for full-segment broadcasting is encoded in conformance with the MPEG-2 Video standard. Video data for one-segment broadcasting is encoded in the H.264 standard. The control module 501 notifies the video decoder 513 whether the input video data is for full-segment broadcasting or one-segment broadcasting.

The audio decoder 514 as a reproduction processing module decodes the audio data. Audio is output from the speakers based on the decoded audio data. The audio data for full-segment broadcasting and one-segment broadcasting is encoded in conformance with the MPEG-2 AAC standard, but the bit rates for full-segment broadcasting and one-segment broadcasting are different. The control module 501 notifies the video decoder 513 whether the input video data is for full-segment broadcasting or one-segment broadcasting.

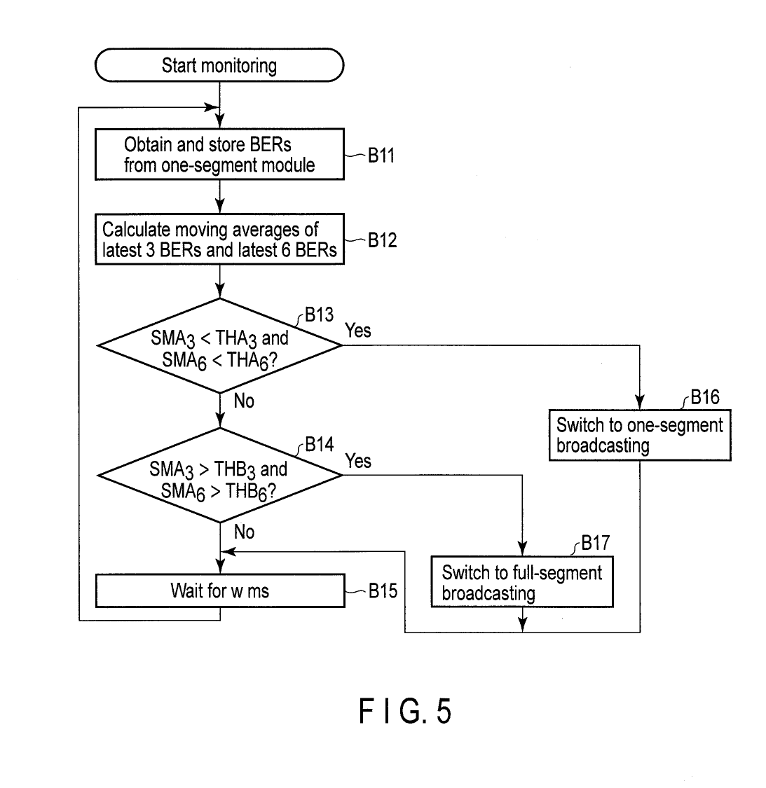

Broadcast signal switch processing will be described below with reference to a flowchart of FIG. 5.

At first, the control module 501 obtains BERs from the one-segment module 420 and stores them in the memory 103 (block B11). The control module 501 calculates a simple moving average SMA₃ of the latest three BERs and a simple moving average SMA₆ of the latest six BERs (block B12).

The control module 501 determines whether SMA₃<TH_{3A} and SMA₆<TH_{6A} are established (block B13). When it is determined that SMA₃<TH_{3A} and SMA₆<TH_{6A} are established (Yes in block B13), the control module 501 requests the TV tuner 30 to output a TS signal for one-segment broadcasting (block B16). The TV tuner 30 outputs a TS signal for one-segment broadcasting in response to the request. When the last request is to output a TS signal for one-segment broadcasting, the control module 501 does not request to output a TS signal for one-segment broadcasting.

When it is determined that SMA₃<TH_{3A} and SMA₆<TH_{6A} are not established (No in block B13), the control module 501 determines whether SMA₃>TH_{3B} and SMA₆>TH_{6B} are established (block B14). When it is determined that SMA₃>TH_{3B} and SMA₆>TH_{6B} are established (Yes in block B14), the control module 501 requests the TV tuner 30 to output a TS signal for full-segment broadcasting (block B17). The TV tuner 30 outputs a TS signal for full-segment broadcasting in response to the request. When the last request is to output a TS signal for full-segment broadcasting, the control module 501 does not request to output a TS signal for one-segment broadcasting.

When it is determined that SMA₃>TH_{3B} and SMA₆>TH_{6B} are not established (No in block B14), when the TV tuner 30 is requested to output a TS signal for one-segment broadcasting (block B16) and when the TV tuner 30 is requested to output a TS signal for full-segment broadcasting (block B17), the control module 501 waits for w ms and then sequentially performs processing subsequent to block B11.

In the embodiment, the simple moving averages of the BERs in a plurality of periods are found and each simple moving average is compared with each threshold corresponding to each simple moving average, thereby requesting to output a TS signal for one-segment broadcasting or a TS signal for full-segment broadcasting. The switching between one-segment broadcasting and full-segment broadcasting according to the present method will be compared with that according to a comparative method. With the comparative method, when V_{BER} is higher than a threshold V_{TH1}, a TS signal for full-segment broadcasting is requested to output, and when V_{BER} is lower than a threshold V_{TH2}, a TS signal for one-segment broadcasting is requested to output.

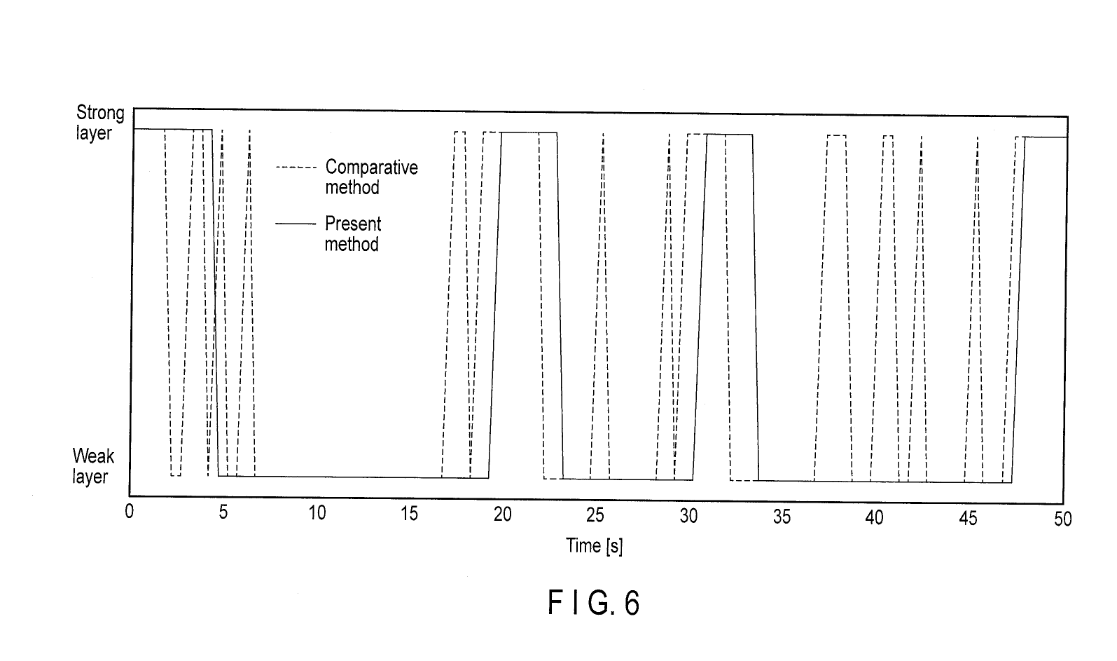

FIG. 6 is a diagram illustrating how to switch one-segment broadcasting and full-segment broadcasting according to the method of the present embodiment and the comparative example.

With the present method and the comparative method, switching is determined based on a BER value V_{BER} obtained per 500 ms. When V_{BER} is lower than 1.00×10⁻⁸, V_{BER} is assumed to be 1.00×10⁻⁸.

With the method according to the present embodiment, it is assumed that TH_{3A} is A (logA=−3.1), TH_{6A} is B (logB=−3), TH_{3B} is B, and TH_{6B} is C (logC=−2.9). That is, when −10×log₁₀(SMA₃) is higher than 31 and −10×log₁₀(SMA₆) is higher than 30, a TS signal for full-segment broadcasting is requested to output, and when −10×log₁₀(SMA₃) is lower than 30 and −10×log₁₀(SMA₆) is lower than 29, a TS signal for one-segment broadcasting is requested to output.

With the comparative method, it is assumed that V_{TH1} is B (logB=−3) and V_{TH2} is C (logC=−2.9). That is, when −10×log₁₀(V_{BER}) is higher than 30, a TS signal for full-segment broadcasting is requested to output, and when −10×log₁₀(V_{BER}) is lower than 29, a TS signal for one-segment broadcasting is requested to output.

As illustrated in FIG. 6, with the comparative method, a TS signal to be output is frequently switched. With the present method, a TS signal to be output is less frequently switched than with the comparative method.

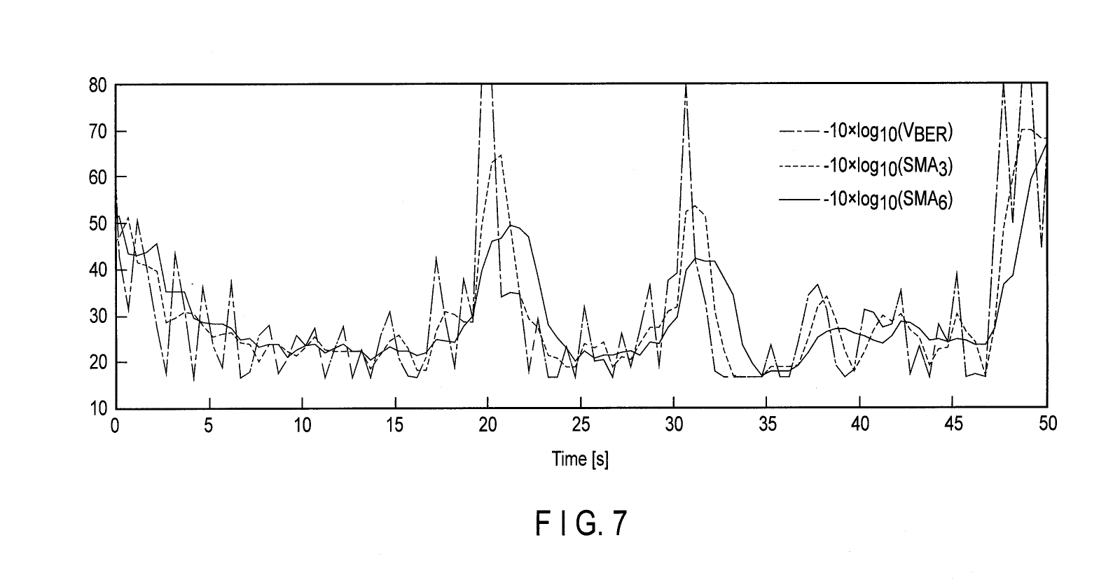

FIG. 7 is a diagram illustrating changes in the BER (V_{BER}), a simple moving average SMA₃ of the latest three BERs, and a simple moving average SMA₆ of the latest six BERs. FIG. 7 illustrates temporal changes in −10×log₁₀(SMA₃), −10×log₁₀(SMA₆), and −10×log₁₀(V_{BER}).

As illustrated in FIG. 7, there is a feature that as the period is longer, the moving average reacts later than an actual movement and becomes smoother. Thus, a threshold corresponding to the moving average in a short sample period is preferably set to be higher than a threshold corresponding to the moving average in a long sample period.

The control module 501 may store the latest nine BERs in the memory 103, and may calculate a simple moving average SMA₃ of three BERs, a simple moving average SMA₆ of the latest six BERs, and a simple moving average SMA₉ of the latest nine BERs in block B12. In this case, instead of the processing in block B13, a determination is made as to whether simple moving average SMA₃ is lower than a threshold (such as 5.01×10⁻⁴) and simple moving average SMA₆ is lower than a threshold (such as 1.00×10⁻³). Instead of the processing in block B14, a determination is made as to whether simple moving average SMA₆ is higher than a threshold (such as 1.00×10⁻⁴) and simple moving average SMA₉ is higher than a threshold (such as 1.00×10⁻³).

A total of periods used to determine switching to full-segment broadcasting is set to be longer than a total of periods used to determine switching to one-segment broadcasting. Since there is a feature that as the period is longer, the moving average reacts later than an actual movement and becomes smoother, a period used to determine switching to full-segment broadcasting is set to be longer than a period used to determine switching to one-segment broadcasting, thereby preventing frequent switching from one-segment broadcasting to full-segment broadcasting.

The two periods are used to determine switching, but three or more periods may be used to determine switching.

The simple moving average is calculated as a moving average, but a later value is more weighted as a moving average to calculate a weighted moving average.

The BER is used as reception quality information, but the carrier-to-noise power ratio may be used as reception quality information.

A tuner capable of outputting a TS signal for one-segment broadcasting and a TS signal for full-segment broadcasting at the same time may be used. In this case, in response to a determination result of the control module 501, the demultiplexer 511 outputs PSI/SI, video data and audio data for one-segment broadcasting to the SI decoder 512, the video decoder 513 and the audio decoder 514, respectively, or the demultiplexer 511 outputs PSI/SI, video data and audio data for full-segment broadcasting to the SI decoder 512, the video decoder 513 and the audio decoder 514, respectively.

According to the present embodiment, the moving averages SMA₃ and SMA₆ of the latest three BERs and the latest six BERs are calculated, when the moving averages SMA₃ and SMA₆ are lower than the first thresholds TH_{3A} and TH_{6A} corresponding to the moving averages SMA₃ and SMA₆, the tuner is requested to output a TS signal for one-segment broadcasting, and when the moving averages SMA₃ and SMA₆ are higher than the first thresholds TH_{3B} and TH_{6B} corresponding to the moving averages SMA₃ and SMA₆, the tuner is requested to output a TS signal for full-segment broadcasting, thereby preventing frequent switching between one-segment broadcasting and full-segment broadcasting.

Various kinds of processing for the switching according to the present embodiment can be realized by a computer program, and thus the computer program is only installed in a typical computer comprising a tuner via a computer readable recording medium storing the computer program therein, thereby easily achieving the same effects as those of the present embodiment.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A receiver comprising:
a tuner configured to receive a strong-layer broadcast signal and a weak-layer broadcast signal from one channel and to output reception quality information based on one of the strong-layer broadcast signal and the weak-layer broadcast signal;
a first calculator configured to calculate a first moving average of the reception quality information output within a first period;
a second calculator configured to calculate a second moving average of the reception quality information output within a second period; and
a reproduction processor configured to reproduce a strong-layer broadcast program based on the strong-layer broadcast signal if the first moving average is lower than a first threshold corresponding to the first moving average, and to reproduce a weak-layer broadcast program based on the weak-layer broadcast signal if the second moving average is higher than a second threshold corresponding to the second moving average.

2. The receiver of claim 1, wherein the reception quality information comprises one of a bit error rate and a carrier-to-noise power ratio.

3. The receiver of claim 1, wherein the first and second moving averages comprise simple moving averages.

4. The receiver of claim 1, wherein the first and second moving averages comprise weighted moving averages which are calculated based on order of output of the reception quality information from the tuner, wherein a weight for obtaining the weighted moving averages is largest for latest reception quality information.

5. The receiver of claim 1, wherein the first calculator and the second calculator are configured to obtain the reception quality information based on the weak-layer broadcast signal.

6. The receiver of claim 1, wherein the second period is longer than the first period.

7. The receiver of claim 1, wherein the tuner is configured to output one of a first signal based on the strong-layer broadcast signal and a second signal based on the weak-layer broadcast signal,
the first calculator is configured to request the tuner to output the first signal when it is determined that the first moving average is lower than the first threshold, and
the second calculator is configured to request the tuner to output the second signal when it is determined that the second moving average is higher than the second threshold.

8. A receiving method for a receiver comprising a tuner configured to receive a strong-layer broadcast signal and a weak-layer broadcast signal from one channel and to output reception quality information based on one of the strong-layer broadcast signal and the weak-layer broadcast signal, the method comprising:
calculating first moving average of the reception quality information output within a first period;
reproducing a strong-layer broadcast program based on the strong-layer broadcast signal if the first moving average is lower than the first threshold;
calculating second moving average of the reception quality information output within a second period; and
reproducing a weak-layer broadcast program based on the weak-layer broadcast signal if the second moving average is higher than the second threshold.

9. A computer-readable, non-transitory storage medium comprising a program which is executable by a computer, the computer comprising a tuner configured to receive a strong-layer broadcast signal and a weak-layer broadcast signal from one channel and to output reception quality information based on the strong-layer broadcast signal or the weak-layer broadcast signal, the program controlling the computer to execute functions of:
calculating first moving average of the reception quality information output within a first period;
reproducing a strong-layer broadcast program based on the strong-layer broadcast signal if the first moving average is lower than the first threshold;
calculating second moving average of the reception quality information output within a second period; and
reproducing a weak-layer broadcast program based on the weak-layer broadcast signal if the second moving average is higher than the second threshold.
